(19) United States
(12) Patent Application Publication
(10) Pub. No.: US 2026/0326411 A1
(43) Pub. Date: Oct. 22, 2026

(54) SANDWICH PANEL STRUCTURE

(71) Applicant: Tusas- Turk Havacilik Ve Uzay Sanayii Anonim Sirketi, Kahramankazan, Ankara (TR)

(72) Inventor: Mehmet SAHIN, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/107,633

(22) PCT Filed: Aug. 25, 2023
(86) PCT No.: PCT/TR2023/050857

§ 371 Date: Feb. 28, 2025

(30) Foreign Application Priority Data
Sep. 1, 2022 (TR) 2022/013684

(51) Int. Cl. B32B 3/12; B32B 7/12; B64C 1/40; B64G 1/58

(52) U.S. Cl. CPC B32B 3/12; B32B 7/12; B64C 1/40; B64G 1/58; B32B 2250/03; B32B 2250/40; B32B 2605/18

(57) ABSTRACT

The present invention relates to at least a first plate (2) and at least a second plate (3) opposite the first plate (2), which are suitable for use in sandwich panels; a plurality of unit cells (4) located between the first plate (2) and the second plate (3); at least one opening (5) located on the surfaces of the unit cell (4) facing the first plate (2) and the second plate (3); a plurality of lateral walls (6) on the unit cell (4), which form the unit cell (4); at least one honeycomb structure (7) consisting of unit cells (4); at least one adhesive (8) between the honeycomb structure (7) and the first plate (2) and the second plate (3), which enables the adhesion of the honeycomb structure (7) to the first plate (2) and the second plate (3).

This invention relates to a sandwich panel structure with a honeycomb structure.

Sandwich panels are used as structural components for the production of vehicles in various sectors such as aviation, space and defense industries, due to their high energy absorption capabilities, advanced mechanical properties and lightweight structures. Honeycomb structure design affects the mechanical performance of sandwich panels consisting of surface sheet and honeycomb structure. Sandwich panel cores are produced in different structures including corrugated, foam, honeycomb and cage. Honeycomb core structures are cell core structures formed by periodically arranging the unit core geometry both horizontally and vertically. The honeycomb core structure consists of periodic core unit cells, similar to corrugated cores. The periodic core unit cells that form the honeycomb core structure enable the core to have a high stiffness and load-carrying capacity. Although the unit cell geometries of honeycomb core structures are generally hexagonal, square and triangular unit cell geometries can also be used for different applications. Honeycomb core structures can be made of different materials depending on the application areas of the sandwich panels. For engineering applications that do not require high strength and hardness, honeycomb cores made of polypropylene (PP), cardboard and plastic materials are preferred due to their lightness advantages, while metallic and composite core materials are used for engineering applications with high mechanical performance requirements. In sandwich panels with a honeycomb structure core, the entire primary load is carried by the surface sheets. Different methods are used in the production of honeycomb cores, including expansion and corrugation. In the expansion process, core slices are combined together with a glue added to the adhesion areas. Honeycomb cores are obtained by stretching the combined cores sliced to a desired size. In the corrugation method, sheet metal forming methods are generally used. The mechanical properties of honeycomb cores vary depending on the impact loading directions, material properties, and the size and thickness of the hexagonal walls. However, the surface where the unit cells contact the adhesive is important in mechanical performance. Since the adhesive surface connecting the honeycomb and the sheets is limited to the cross-sectional surface area of the honeycomb, adhering the sheets directly onto the honeycomb creates some problems. Due to the limited adhesion mentioned, the small cross-sectional area between the sheet and the honeycomb cannot provide sufficient connection under loading, such that the sheet and the honeycomb breaks, causing local separations and buckling. Another problem is inadequate adhesion or no connection at all, between the sheet and the honeycomb during production. This causes production errors, and therefore loss of strength. In addition, when subjected to loading along the vertical axis, lower and upper parts of the honeycomb walls are subject to local buckling under less load in depth, as there are not sufficient restrictions. However, since thin-walled uncoated plain honeycomb has a very flexible structure along the plane, it should be protected, handled and processed carefully. This creates extra costs and/or may increase product loss. A further problem is that metal honeycomb is especially suitable for heat conduction, but since the heat conduction between the inner and outer surfaces of the panel is limited to the cross-sectional area of honeycomb, heat conduction is restricted. Moreover, adhesive between the honeycomb and the sheet reduces heat conduction in these limited areas.

EP1866489, which is included in the known-state of the art, discloses an acoustic structure consisting of a honeycomb with cells in which the septum caps are located. The septum caps according to the invention are formed from sheets of acoustic material and include a resonator portion and a flange portion. The flange portion has an anchoring surface that provides frictional engagement of the septum caps to the honeycomb cells when the caps are inserted into the honeycomb during fabrication of the acoustic structure. An adhesive is applied to the anchoring surface of the septum caps after the caps have been inserted into the honeycomb cells to provide a permanent bond.

U.S. Pat. No. 6,274,216, which is included in the known-state of the art, discloses that a honeycomb structure is strengthened by intermediate membranes, which compartmentalize the cells in the vertical direction. The structure according to the invention has an increased mechanical strength and high damping properties for Helmholtz resonators intended to trap sound waves arriving on the structure.

U.S. Pat. No. 4,632,862, which is included in the known-state of the art, discloses a honeycomb structure with cells forming I-beams. Application areas requiring both strength and lightness uses said honeycomb structure material with the I-beams being stacked one upon another and spaced apart throughout the web.

Thanks to a sandwich panel structure according to the present invention, caps on the honeycomb are folded so that an adhesion surface area between the sheet and the caps increases, allowing the cap to fully adhere to the sheet.

Another object of the present invention is to reduce the possibility of non-contact or partial contact of the adhesive due to the increasing adhesion surface area between the sheet and the honeycomb during production. Therefore, production errors are reduced.

A further object of the present invention is to increase the resistance to local buckling by providing sufficient movement restriction and increased local separation resistance for the honeycomb walls.

Yet another object of the present invention is to reduce the need for local additional reinforcement sheets, and accordingly, to increase lightness and local strength and stiffness.

Still another object of the present invention is to provide better heat conduction since the honeycomb walls and sheet surfaces are continuous and uninterrupted.

Another object of the present invention is to provide practical, durable, effective and easy sandwich panel structure production.

The sandwich panel structure realized to achieve the object of the invention, which is defined in the first claim and other claims dependent thereon, comprises at least a first plate and at least a second plate opposite the first plate, which are suitable for use in honeycomb sandwich panels; a plurality of hollow unit cells located between the first plate and the second plate; at least one opening on the surfaces where both the lower base and the upper base of the unit cell contact the first plate or the second plate or the adhesive; a plurality of lateral walls forming the unit cell by extending vertically in a hexagonal structure along the wall edges of the unit cell; at least one honeycomb structure between the first plate and the second plate, which is formed by unit cells combined together; an adhesive in fluid or film form, which enables the adhesion of both the lower base and the upper base to the first plate and the second plate between which the honeycomb structure is provided. There is an adhesive between the honeycomb structure and the first plate and the second plate. The interior of the unit cell surrounding the lateral walls is hollow. The adhesive is applied by the manufacturer to adhere the unit cells to the first plate and the second plate. The adhesive is provided as a film layer or is applied in a fluid form to the unit cell or the first plate and the second plate. The first plate and the second plate can be made of composite or metal materials.

The sandwich panel structure according to the invention comprises at least one cap produced integrally with the unit cell, adhered by the manufacturer to the first plate and/or the second plate by means of adhesive, and extending outwards from at least one of the lateral walls so as to overlap or contact with the first plate and/or the second plate and to at least partially close the opening. Caps on the unit cell are folded by the manufacturer at the wall boundaries of the unit cell to cover the opening. In this way, adhesion surface area of the unit cell with the first plate and the second plate is increased, thanks to the caps. The caps cover the upper and lower base of the unit cell, at least partially covering the opening. The caps extend from the lateral walls towards the first plate and the second plate, and all of the unit cells are folded equally by the manufacturer.

In an embodiment of the invention, the sandwich panel structure comprises a cavity or slit between two consecutive caps. It comprises the cap located at only one of the consecutive and adjacent lateral walls extending along the honeycomb structure. Thus, the surface area where the honeycomb structure is adhered with adhesive, increases. There is a row of cavities and caps on each lateral wall. Additionally, a slit is provided between both consecutive and adjacent lateral walls. In this way, a smoother adhesion surface is obtained when the caps are folded.

In an embodiment of the invention, the sandwich panel structure comprises the cap folded/bent by the manufacturer such that the opening on the unit cell is at least partially covered. The honeycomb structure is formed by bending/folding the caps at the wall boundaries of the unit cell into the unit cell center or out of the unit cell center by the manufacturer. Honeycomb structure can be made of composite, plastic or metal materials.

In an embodiment of the invention, the sandwich panel structure comprises the unit cell with caps that are form-compatible when two opposing caps almost completely cover the opening. The openings in the lower and upper bases of the unit cell are almost completely closed by the caps located on the opposite lateral walls in a form-compatible manner.

In an embodiment of the invention, the sandwich panel structure comprises the unit cell consisting of caps which become adjacent when folded by the manufacturer to almost completely cover the opening. There are successive caps on each of the lateral walls on the unit cell. Therefore, the adhesion surface area of the honeycomb structure consisting of unit cells increases.

In an embodiment of the invention, the sandwich panel structure comprises the unit cell consisting of caps that remain opposite each other, in almost complete contact with each other, when closed by the manufacturer. The caps are located to at least partially close the opening when folded.

In an embodiment of the invention, the sandwich panel structure comprises the unit cell having a hexagonal structure with lateral walls, and consisting of caps with triangular, rectangular, square or trapezoidal shapes on lateral walls thereof. The unit cell, which has a hexagonal honeycomb form, comprises the cap with a triangular, square, rectangular or trapezoidal shape.

In an embodiment of the invention, the sandwich panel structure comprises at least a first sheet forming the unit cell; at least one second sheet mirror symmetrical to the first sheet, which is adhered to the first plate gradually, back-to-back with a distance therebetween; the lateral wall facing each other when the first sheet and the second sheet are pulled open by the manufacturer. Additionally, the first sheet and the second sheet can be adhered back-to-back, skipping one row from the parts where they are adhered. The first sheet and the second sheet located along a strip are bent individually to create structures with recesses and protrusions. The first sheet and the second sheet are adhered opposite to each other and pulled open by the manufacturer. Thus, sandwich panels with a honeycomb structure are produced.

In an embodiment of the invention, the sandwich panel structure comprises the cap with a shape desired by the user by cutting the first sheet and the second sheet at the parts determined by the manufacturer. The caps, which are produced integrally with the first sheet and the second sheet, are obtained by cutting at the boundaries determined by the user. Thus, sandwich panels can be produced according to the usage area.

In an embodiment of the invention, the sandwich panel structure comprises the honeycomb structure obtained by an additive manufacturing method, which provides ease of production thanks to the caps located on the first sheet and the second sheet integrally.

In an embodiment of the invention, the sandwich panel structure comprises the cap extending outward from at least one of the lateral walls to completely cover the opening at the lower and upper base of the unit cells. The adhesion surface is increased thanks to the caps cut from each corner of the unit cell to cover the opening.

In an embodiment of the invention, the sandwich panel structure comprises the honeycomb structure suitable for use in air and/or space vehicles.

The sandwich panel structure realized to achieve the object of the present invention is illustrated in the attached drawings, in which:

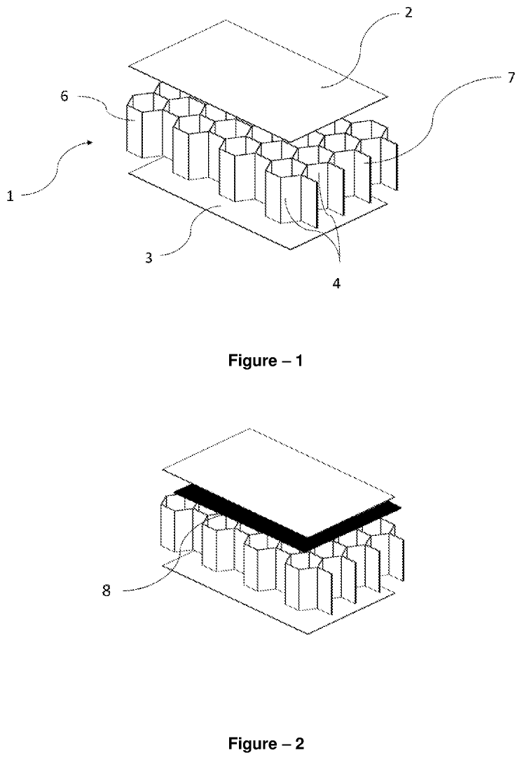

FIG. 1 is a perspective view of the sandwich panel structure.

FIG. 2 is a schematic view of the adhesive on the sandwich panel structure.

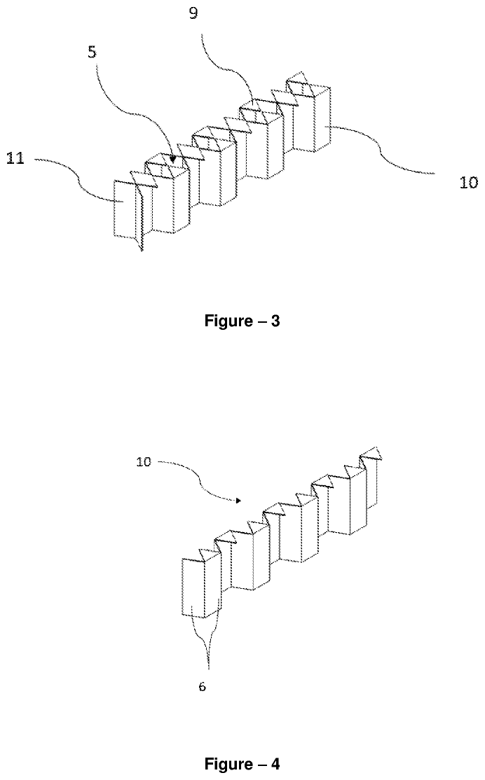

FIG. 3 is a perspective view of unit cells.

FIG. 4 is a schematic view of the first sheet.

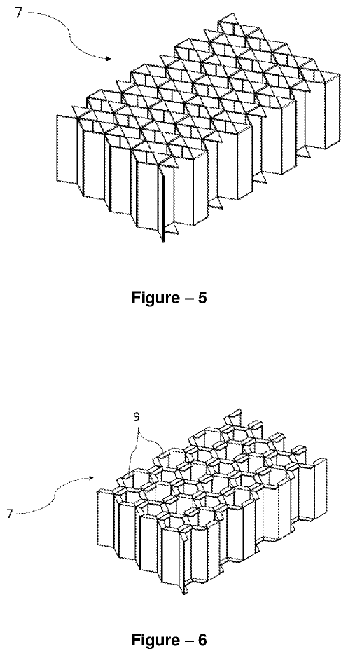

FIG. 5 is a schematic view of the honeycomb structure.

FIG. 6 is an alternative schematic view of the honeycomb structure.

FIG. 7 is an alternative schematic view of the first sheet.

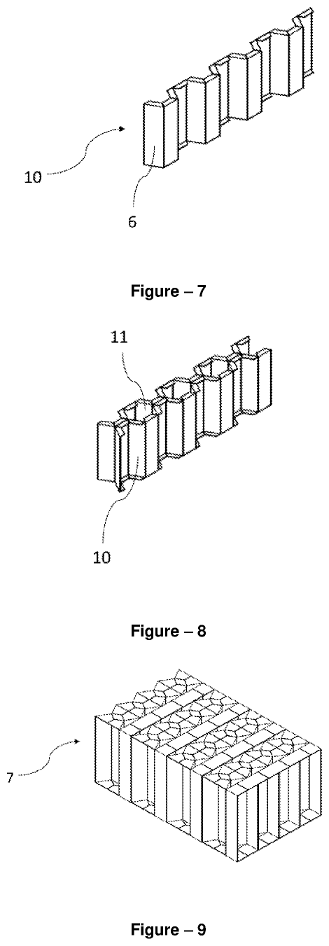

FIG. 8 is an alternative schematic view of unit cells.

FIG. 9 is an alternative schematic view of the honeycomb structure.

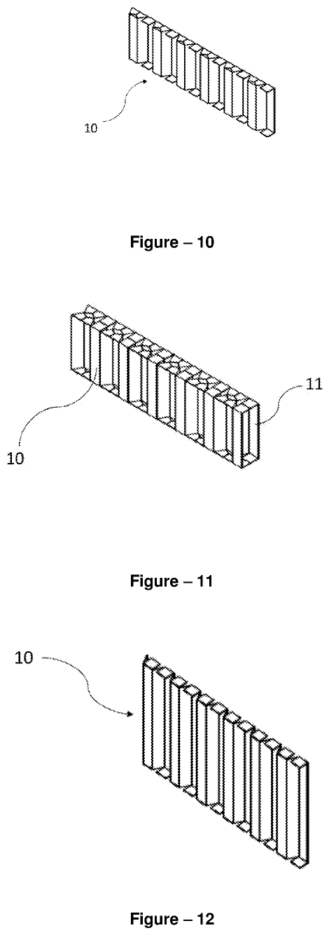

FIG. 10 is an alternative schematic view of the first sheet.

FIG. 11 is an alternative schematic view of unit cells.

FIG. 12 is an alternative schematic view of the first sheet.

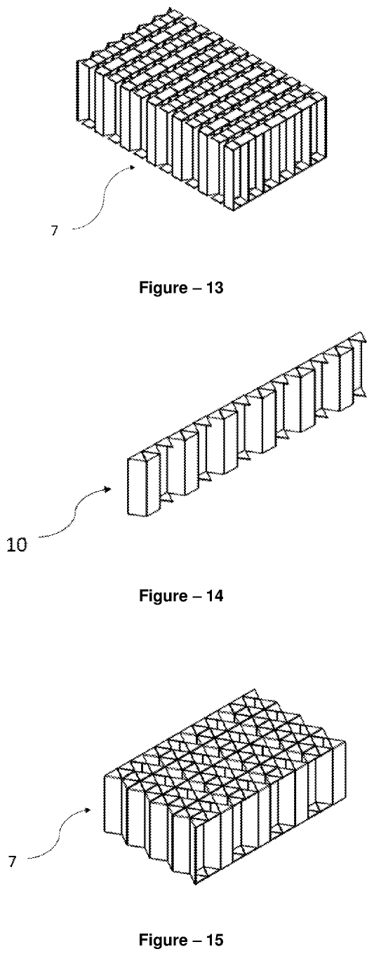

FIG. 13 is an alternative schematic view of the honeycomb structure.

FIG. 14 is an alternative schematic view of the first sheet.

FIG. 15 is an alternative schematic view of the honeycomb structure.

All the parts illustrated in figures are individually assigned a reference numeral and the corresponding terms of these numbers are listed below:
1. Sandwich Panel Structure
2. First Plate
3. Second Plate
4. Unit Cell
5. Opening
6. Lateral Wall
7. Honeycomb Structure
8. Adhesive
9. Cap
10. First Sheet
11. Second Sheet

The sandwich panel structure (1) comprises at least a first plate (2) and at least a second plate (3) opposite the first plate (2), which are suitable for use in sandwich panels; a plurality of unit cells (4) located between the first plate (2) and the second plate (3); at least one opening (5) located on the surfaces of the unit cell (4) facing the first plate (2) and the second plate (3); a plurality of lateral walls (6) on the unit cell (4), which form the unit cell (4); at least one honeycomb structure (7) consisting of unit cells (4); at least one adhesive (8) between the honeycomb structure (7) and the first plate (2) and the second plate (3), which enables the adhesion of the honeycomb structure (7) to the first plate (2) and the second plate (3) (FIG. 1, FIG. 2).

The sandwich panel structure (1) according to the invention comprises at least one cap (9) produced integral with the unit cell (4), extending outward from at least one of the lateral walls (6) to at least partially cover the opening (5) and allowing the unit cell (4) to be connected to the first plate (2) and/or the second plate (3) by means of the adhesive (8) such that the unit cell (4) almost completely takes the final shape desired by the manufacturer (FIG. 3, FIG. 4).

It comprises at least a first plate (2) and at least a second plate (3) opposite the first plate (2), which are suitable for use in honeycomb sandwich panels; a plurality of unit cells (4) placed by the manufacturer between the first plate (2) and the second plate (3); at least one opening (5) located on the wall boundaries of the unit cell (4), on both the lower and upper base of the unit cell (4); a plurality of lateral walls (6) surrounding the unit cell (4) and enabling the unit cell (4) to have a hexagonal structure; at least one honeycomb structure (7) consisting of unit cells (4); at least one adhesive (8) located on both surfaces of the honeycomb structure (7), in the parts where it contacts the first plate (2) and the second plate (3), the adhesive (8) enabling the honeycomb structure (7) to adhere to both the first plate (2) and the second plate (3). The adhesive (8) ensures that the unit cell (4) located between the first plate (2) and the second plate (3) adheres to the first plate (2) and the second plate (3). Thanks to the opening (5) on the unit cell (4), the unit cell (4) has a light and flexible structure. The lateral walls (6) are angular and surround the unit cell (4). The adhesive (8) may be in a fluid or a solid form (FIG. 5, FIG. 6, FIG. 7, FIG. 8, FIG. 9, FIG. 10).

It comprises at least one cap (9) produced integral with the unit cell (4) and located on the unit cell (4) so as to extend outward from at least one of the lateral walls (6) to at least partially cover the opening (5), wherein the cap (9) is adhered to the first plate (2) and the second plate (3) by means of adhesive (8), such it almost completely takes the final shape desired by the manufacturer. The cap (9) integral with the unit cell (4) is cut into a desired shape by the manufacturer. The caps (9) extend from at least one of the lateral walls (6) to at least partially contact the first plate (2) and/or the second plate (3). The caps (9) at least partially close the openings (5) located on both surfaces of the unit cell (4). The caps (9) are adhered on the first plate (3) and the second plate (3) with adhesive (8) in between (FIG. 11, FIG. 12, FIG. 13, FIG. 14, FIG. 15).

In an embodiment of the invention, the sandwich panel structure (1) comprises consecutive and adjacent lateral walls (6) extending along the honeycomb structure (7); the cap (9) located on only one of the lateral walls (6). There is a cap (9) on only one of the adjacent lateral walls (6), which are located as a strip on the honeycomb structure (7) and form unit cells (4). In this way, when the caps (9) are closed, the opening (5) is almost completely closed (FIG. 4, FIG. 12).

In an embodiment of the invention, the sandwich panel structure (1) comprises the cap (9) formed by folding/bending by the manufacturer to at least partially cover the opening (5). It comprises the cap (9) that is bent by the manufacturer or folded at the wall boundaries of the unit cell (4), thereby at least partially closing the opening (5).

In an embodiment of the invention, the sandwich panel structure (1) comprises the unit cell (4) formed such that two opposite caps (9) almost completely cover the opening (5) in a form-compatible manner. The caps (9), which are cut opposite each other by the manufacturer and then folded, almost completely close the opening (5).

In an embodiment of the invention, the sandwich panel structure (1) comprises the unit cell (4) consisting of caps (9) that are side by side when folded by the manufacturer to cover the opening (5). It comprises the caps (9) that are adjacent to each other and arranged one after the other when folded by the manufacturer (FIG. 6, FIG. 7).

In an embodiment of the invention, the sandwich panel structure (1) comprises the unit cell (4) consisting of caps (9) which are folded by the manufacturer to remain opposite and almost completely contact each other. It comprises caps (9), which are located opposite each other when folded by the manufacturer, and almost completely contact with each other when closed (FIG. 3, FIG. 4, FIG. 5).

In an embodiment of the invention, the sandwich panel structure (1) comprises the unit cell (4) with a hexagonal form thanks to the lateral walls (6) thereof, wherein a cap (9) with a triangular, rectangular, square or trapezoidal shape is provided on the lateral wall (6). The lateral walls (6) forming the unit cells (4) are located to form the unit cells (4) with a hexagonal structure. The cap (9) may have a triangular, rectangular or square shape, as desired by the user.

In an embodiment of the invention, the sandwich panel structure (1) comprises at least a first sheet (10) that enables the formation of the unit cell (4); at least a second sheet (11) mirror symmetrical to the first sheet (10), which is adhered gradually to the first sheet (10) so as to be opposite the first sheet (10) with a distance therebetween; the unit cell (4) formed by the space between the adhered first sheet (10) and the second sheet (11). It comprises lateral walls (6) remaining opposite each other when the first sheet (10) and the second sheet (11) are pulled open by the manufacturer (FIG. 3, FIG. 8, FIG. 11).

In an embodiment of the invention, the sandwich panel structure (1) comprises the cap (9) on the first sheet (10) and the second sheet (11), which is cut by the manufacturer to be produced. It comprises the cap (9) produced integral with the first sheet (10) and the second sheet (11), and which is cut by the manufacturer to have the desired form.

In an embodiment of the invention, the sandwich panel structure (1) comprises the honeycomb structure (7) produced integral with the cap (9) by an additive manufacturing method. Therefore, an easy-to-produce sandwich panel structure is obtained.

In an embodiment of the invention, the sandwich panel structure (1) comprises the cap (9) extending outward from at least one of the lateral walls (6) to completely cover the opening (5). It comprises the caps (9) that completely cover the opening (5) without leaving any space therebetween when closed by the manufacturer (FIG. 14, FIG. 15).

In an embodiment of the invention, the sandwich panel structure (1) comprises the honeycomb structure (7) suitable for use in air and/or space vehicles.

1. A sandwich panel structure (1) comprising at least a first plate (2) and at least a second plate (3) opposite the first plate (2), which are suitable for use in sandwich panels; a plurality of unit cells (4) located between the first plate (2) and the second plate (3); at least one opening (5) located on the surfaces of the unit cell (4) facing the first plate (2) and the second plate (3); a plurality of lateral walls (6) on the unit cell (4), which form the unit cell (4) consecutive and adjacent extending along the honeycomb structure (7); at least one honeycomb structure (7) consisting of unit cells (4); at least one adhesive (8) between the honeycomb structure (7) and the first plate (2) and the second plate (3), which enables the adhesion of the honeycomb structure (7) to the first plate (2) and the second plate (3), wherein at least one cap (9) produced integral with the unit cell (4) and located on only one of the lateral walls (6), extending outward from at least one of the lateral walls (6) to at least partially cover the opening (5) and allowing the unit cell (4) to be connected to the first plate (2) and/or the second plate (3) by means of the adhesive (8) such that the unit cell (4) takes the final shape desired by the manufacturer.

2. (canceled)

3. A sandwich panel structure (1) according to claim 1, wherein the cap (9) formed by folding/bending by the manufacturer to at least partially cover the opening (5).

4. A sandwich panel structure (1) according to claim 1, wherein the unit cell (4) formed such that two opposite caps (9) almost completely cover the opening (5) in a form-compatible manner.

5. A sandwich panel structure (1) according to claim 1, wherein the unit cell (4) consisting of caps (9) that are side by side when folded by the manufacturer to cover the opening (5).

6. A sandwich panel structure (1) according to claim 1, wherein the unit cell (4) consisting of caps (9) which are folded by the manufacturer to remain opposite and almost completely contact each other.

7. A sandwich panel structure (1) according to claim 1, wherein the unit cell (4) with a hexagonal form thanks to the lateral walls (6) thereof, wherein a cap (9) with a triangular, rectangular, square or trapezoidal shape is provided on the lateral wall (6).

8. A sandwich panel structure (1) according to claim 1, wherein at least a first sheet (10) that enables the formation of the unit cell (4); at least a second sheet (11) mirror symmetrical to the first sheet (10), which is adhered gradually to the first sheet (10) so as to be opposite the first sheet (10) with a distance therebetween; the unit cell (4) formed by the space between the adhered first sheet (10) and the second sheet (11).

9. A sandwich panel structure (1) according to claim 8, wherein the cap (9) on the first sheet (10) and the second sheet (11), which is cut by the manufacturer to be produced.

10. A sandwich panel structure (1) according to claim 1, wherein the honeycomb structure produced integral with the cap (9) by an additive manufacturing method.

11. A sandwich panel structure (1) according to claim 1, wherein the cap (9) extending outward from at least one of the lateral walls (6) to completely cover the opening (5).

12. A sandwich panel structure (1) according to claim 1, wherein the honeycomb structure (7) suitable for use in air and/or space vehicles.
